(19) United States
(12) Patent Application Publication
(10) Pub. No.: US 2012/0086636 A1
(43) Pub. Date: Apr. 12, 2012

(54) SENSOR RING AND INTERACTIVE SYSTEM HAVING SENSOR RING

(75) Inventor: GA-LANE CHEN, Santa Clara, CA (US)

(73) Assignee: HON HAI PRECISION INDUSTRY CO., LTD., Tu-Cheng (TW)

(21) Appl. No.: 12/947,806

(22) Filed: Nov. 16, 2010

(30) Foreign Application Priority Data
Oct. 8, 2010 (TW) 99134302

(51) Int. Cl. G06F 3/033

(52) U.S. Cl. 345/158

(57) ABSTRACT

This disclosure provides a sensor ring and an interactive system having the sensor ring. The interactive system includes the sensor ring, a RF receiver, an image-capture device and a signal processor. The sensor ring is adopted for wear on fingers or toes, has a sensor module to produce a sensing signal, and a RF transmitter for transmission of sensing signals. The image-capture device has a camera module used to produce a detection signal. The RF receiver receives the sensing signals of the ring. The signal processor processes the sensing signals of the rings and the detection signals of the image-capture device to produces interactive operation.

### BACKGROUND

1. Technical Field

The present disclosure relates to interactive systems, and particularly, to a sensor ring having a gyroscope sensor and a related interactive system.

2. Description of Related Art

Human-machine interfaces can be found in many popular consumer products such as laptop computers, media players, game station, and mobile phones. The human-machine interfaces include input devices for receiving user input. Until now, input devices typically can only measure simple motions of an object, such as a linear motion in certain directions or angles that limit the amount of fine detail of motion that can be captured and understood as user commands.

Accordingly, it is desirable to provide a human-machine interface which can overcome the described limitations.

### BRIEF DESCRIPTION OF THE DRAWINGS

Many aspects of the disclosure can be better understood with reference to the drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a schematic view of one embodiment of an interactive system having a sensor ring, according to the present disclosure.

FIG. 2 is a block diagram of one embodiment of the sensor ring of FIG. 1.

FIG. 3 is a block diagram of one embodiment of the interactive system of FIG. 1.

### DETAILED DESCRIPTION

Embodiments of the present sensor ring and interactive system having the sensor ring will now be described in detail with reference to the drawings.

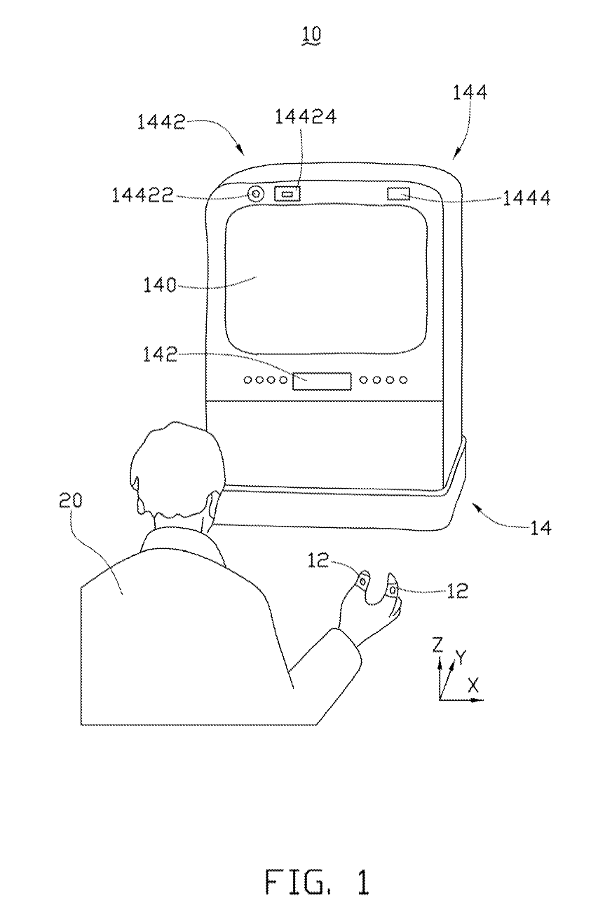

As shown in FIG. 1, one embodiment of an interactive system 10 including a sensor ring 12 and a display 14 is shown. The sensor ring 12 is a small electronic device that may be adapted to be worn on a finger or even on a toe of the user 20 to cooperate with the display 14. The numbers of the sensor ring 12 and the display 14 are not limited to this embodiment. For example, the interactive system 10 may include more than one sensor ring 12 to cooperate with one display 14, and more than one user 20 can operate the interactive system 10 at the same time.

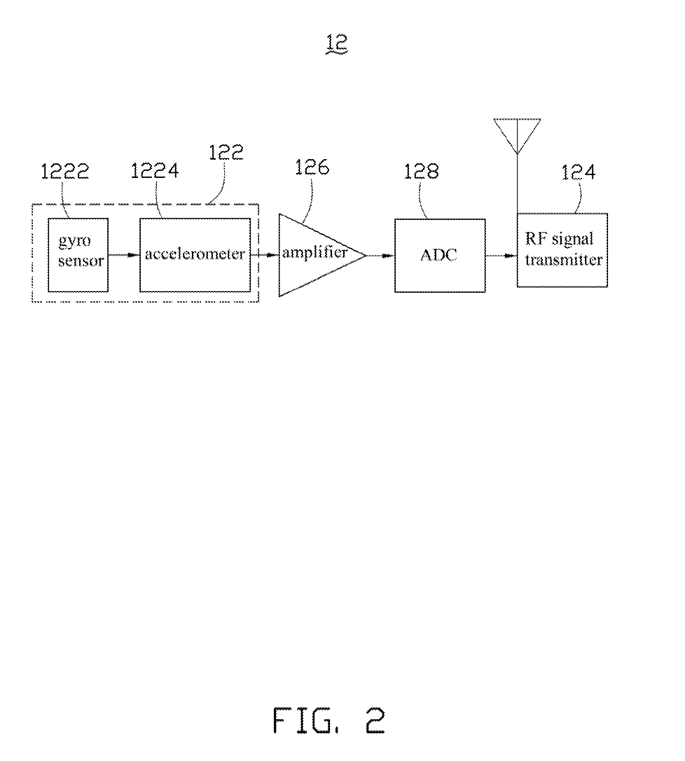

In one example, the sensor ring 12 is a transducer or a combination of transducers configured to convert movements of the user 20 into sensing signals. The sensor ring 12 includes a sensor module 122 and a radio frequency (RF) signal transmitter 124 electrically connected to the sensor module 122, as shown in FIG. 2. The sensor module 122 includes a gyroscope sensor 1222 and an accelerometer 1224. The gyroscope sensor 1222 can measure the angular velocity and angular acceleration of the corresponding finger or toe, and the accelerometer 1224 can measure the linear acceleration of the movement. Thus, the sensor ring 12 can measure the angular velocities and angular accelerations in the XY, YZ, ZX planes, and the accelerations along X, Y, Z coordinate axis directions. Accordingly, actions of the user 20, such as pitch, yaw and roll of the finger, the toe and even the arm and leg are detected and converted into analog sensing signals by the sensor module 122. In other embodiments, the sensor ring 12 may include more than one gyroscope sensor 1222 and more than one accelerometer 1224. Foe example, the sensor ring may includes three gyroscope sensors 1222 respectively located along X, Y, Z coordinate axis directions, and respectively measure the angular acceleration in the X, Y, Z axis directions.

The sensor ring 12 may further include an amplifier 126 and an analog-to-digital converter (ADC) 128 electrically connected to the amplifier 126. The amplifier 126 increases the amplitude of the analog sensing signals from the sensor module 122. Thus, differences in fine movements of the finger or toe can be sensed. The ADC 128 is an electronic device that converts the analog sensing signals enlarged by the amplifier 126 into a digital sensing signal. The RF signal transmitter 124 receives the digital sensing signal from the ADC 128 and transmits the digital sensing signal.

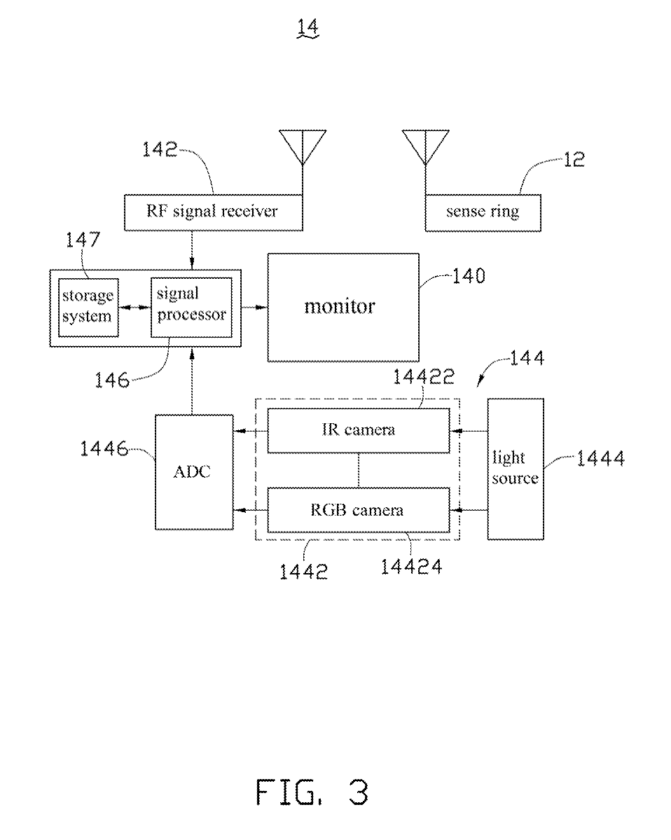

As shown in FIG. 3, the display 14 includes a monitor 140, and the interactive system 10 further includes an RF signal receiver 142, an image-capture device 144, a storage system 147 and a signal processor 146 electrically connected to the monitor 140.

The RF signal receiver 142 receives the digital sensing signal transmitted from the sensor ring 12. The RF signal receiver 142 may be located in front of the sensor ring 12, for example on a surface of the monitor 140 of the display 14, as shown in FIG. 1. The monitor 140 can be any kind of monitor, such as a light emitting diode (LED) television, a liquid crystal display (LCD) television, a monitor of a network computer, a notebook computer, a monitor of a mobile phone, a monitor of a personal digital assistant (PDA), a digital photo frame or a monitor of play station.

The image-capture device 144 captures images in front. When the user 20 stands or moves in front of the image-capture device 144, an image of the user 20 can be recognized from the taken image. Accordingly, a position and a profile of the user 20 can be detected. The image-capture device 144 includes a camera module 1442 and a light source 1444. The camera module 1442 includes an infrared (IR) camera 14422 and a red, green, and blue (RGB) camera 14424 located in front of the sensor ring 12, for example on a surface of the monitor 140 of the display 14. The IR camera 14422 may include a narrow band filter (NBF, not labeled). The NBF enables the IR camera 14422 to determine distance to the user 20 along the direction perpendicular to the monitor 140. The NBF may be a multi-layer optical filter with a bandwidth from about 2 μm to about 20 μm. In this embodiment, the bandwidth of the NBF is in a range from about 5 μm to about 12 μm.

The light source 1444 can also be located in front of the sensor ring 12, for example on the surface of the monitor 140. The light source 1444 includes an IR LED unit and a diffraction optical element (DOE, not labeled) in front of the IR LED unit. The DOE enlarges the area illuminated by IR light, so the detecting area is also enlarged. Since the camera module 1442 can receive the IR light reflected from the user 20, the image-capture device 144 can capture images of the user 20 even in limited light conditions, and provides a detection signal to an ADC 1446. The detection signal provided by the camera module 1442 is an analog detection signal about image data.

The ADC 1446 converts the detection signal provided from the camera module 1442 to a digital detection signal, and transmits the digital detection signal to a signal processor 146.

The signal processor 146 receives the sensing signals from the sensor ring 12 and the detection signal from the camera module 1442, processes the received sensing and detection signals, and provides a control signals to the monitor 140. The storage system 147 supports and cooperates with the signal processor 146. The monitor 140 display images according to the control signals, for example, an avatar of the user 20 may move in way the mimics the user 20. Accordingly, the interactive system 10 can interact with the user 20.

The configurations and arrangements of the RF signal receiver 142, the image-capture device 144, the storage system 147 and the signal processor 146 are not limited by this embodiment. In other embodiments, the RF signal receiver 142, the image-capture device 144, the storage system 147 and the signal processor 146 may be assembled in one apparatus; or the RF signal receiver 142 and the image-capture device 144 are assembled in one apparatus, and the storage system 147 and the signal processor 146 are assembled in another apparatus.

The sensor ring 12 of the present disclosure can accurately sense gross and fine movements of the user 20, which makes interactive operations more realistic and sensitive. The camera module 1442, the light source 1444, the DOE and the NBF also enhance the sensitivity and accuracy of the interactive system 10.

Due to its great sensitivity and accuracy, the interactive system 10 can allow the playing of three-dimensional (3D) interactive games by more than one user 20 and provide a highly realistic telepresence. Such games may include, for example, basketball, baseball, handball, tennis, soccer, rugby and so on. In addition to the interactive games, the interactive system 10 can also be applied to global positioning systems (GPS), automotive navigation systems and other input apparatus, and requires no keyboard or complicated buttons. Thus, various applications of the present disclosure are practicable.

It will be understood that the above particular embodiments and methods are shown and described by way of illustration only. The principles and the features of the present disclosure may be employed in various and numerous embodiments thereof without departing from the scope and spirit of the disclosure as claimed. The above-described embodiments illustrate the scope of the disclosure but do not restrict the scope of the disclosure.

What is claimed is:

1. An interactive system, comprising:
a sensor ring comprising a gyroscope sensor, an accelerometer, and a radio frequency transmitter, the radio frequency transmitter operable to send a sensing signal according to movement data of the gyroscope sensor and the accelerometer;
a radio frequency receiver operable to receive the sensing signal;
an image-capture device operable to capture images of a user and provide a detection signal according to movement of the images; and
a signal processor operable to provide a control signal to a monitor to display images according to the sensing signal and the detection signal.

2. The interactive system of claim 1, wherein the sensor ring is adapted to be worn by a finger or toe of the user.

3. The interactive system of claim 1, wherein at least one of the radio frequency receiver, the image capturing device, and the signal processor are integrated with the monitor.

4. The interactive system of claim 1, wherein at least one of the radio frequency receiver and the image capturing device are mounted on the monitor.

5. The interactive system of claim 1, wherein the image-capture device comprises a camera module and a light source.

6. The interactive system of claim 1, wherein the camera module comprises an infrared (IR) camera and a red, green and blue (RGB) camera.

7. The interactive system of claim 6, wherein the infrared camera comprises a narrow band filter (NBF).

8. The interactive system of claim 7, wherein the narrow band filter is a multi-layer optical filter.

9. The interactive system of claim 7, wherein a bandwidth of the diffraction optical element is in a range from about 5 μm to about 12 μm.

10. The interactive system of claim 6, wherein the light source comprises an IR LED unit.

11. The interactive system of claim 10, wherein the light source comprises a diffraction optical element (ODE) in front of the IR LED unit.

12. An interactive system, comprising:
a sensor ring comprising a gyroscope sensor, an accelerometer, and a radio frequency transmitter, the radio frequency transmitter operable to send a sensing signal according to movement data of the gyroscope sensor and the accelerometer;
a radio frequency signal receiver operable to receive the sensing signal; and
a signal processor operable to provide a control signal to a monitor to display images according to the sensing signal.

13. The interactive system of claim 12, wherein the at least one sensor ring further comprises an amplifier and a first analog-to-digital converter.

14. The interactive system of claim 12, further comprising an image-capture device located in front of the at least one sensor ring.

15. The interactive system of claim 14, wherein the image-capture device comprises a camera module operable to provide a detection signal.

16. The interactive system of claim 15, wherein the image-capture device comprises a camera module and a light source.

17. The interactive system of claim 15, wherein the camera module comprises an infrared (IR) camera and a red, green and blue (RGB) camera.

18. The interactive system of claim 16, wherein the light source comprises an IR LED unit.

19. A sensor ring, comprising:
a gyroscope sensor;
an accelerometer; and
a radio frequency signal transmitter operable to send a sensing signal according to movement data of the gyroscope sensor and the accelerometer.

20. The sensor ring of claim 19 further comprising an amplifier operable to increase amplitude of the sensing signal.
